(19) United States
(12) Patent Application Publication
(10) Pub. No.: US 2016/0048857 A1
(43) Pub. Date: Feb. 18, 2016

(54) SYSTEMS AND METHODS OF COLLECTING DATA TO DETERMINE INTEREST

(71) Applicants: Chintan Jain, Ashburn, VA (US); Rui Kong, Lake Oswego, OR (US)

(72) Inventors: Chintan Jain, Ashburn, VA (US); Rui Kong, Lake Oswego, OR (US)

(21) Appl. No.: 14/458,045

(22) Filed: Aug. 12, 2014

(51) Int. Cl. G06Q 30/02; H04W 4/02

(52) U.S. Cl. CPC G06Q 30/0205; H04W 4/021

(57) ABSTRACT

System and methods directed to collection of data to determine interest is herein described. An area that is a pre-defined distance from a brick-and-mortar store is identified. An indication is received from a mobile device associated with a user, the indication being received based on geofence data that indicates a geofence that surrounds the identified area. In response to receipt of the indication, data from the mobile device is periodically collected. A determination that the data collected from the mobile device indicates interest in the brick-and-mortar store is performed. A notification to the mobile device is presented based on the determination.

### TECHNICAL FIELD

The subject matter disclosed herein generally relates to the processing of data. Specifically, the present disclosure addresses systems and methods to facilitate collection of data to determine interest.

### BACKGROUND

A geofence may be set up around a brick-and-mortar store. Moreover, a server may monitor the geofence for activity and subsequently present a notification to a user that crosses the geofence.

### BRIEF DESCRIPTION OF THE DRAWINGS

Some embodiments are illustrated by way of example and not limitation in the figures of the accompanying drawings.

FIG. 1 is a network diagram illustrating a network environment suitable for collecting data to determine interest, according to some example embodiments.

FIG. 2 is a block diagram illustrating components of a server machine suitable for determining that data collected from a mobile device indicates interest in a brick-and-mortar store, according to some example embodiments.

FIG. 3-4 are example user interfaces illustrating a notification presented on a screen of a mobile device, according to some example embodiments.

FIG. 5-8 are flowcharts illustrating operations of a server machine in performing a method of determining that data collected from a mobile device indicates interest in a brick-and-mortar store, according to some example embodiments.

FIG. 9 is a block diagram illustrating components of a machine, according to some example embodiments, able to read instructions from a machine-readable medium and perform any one or more of the methodologies discussed herein.

### DETAILED DESCRIPTION

Example methods and systems are directed to collection of data to determine interest. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A geofence may be set up around a brick-and-mortar store. Moreover, a server may monitor the geofence for activity and subsequently present a notification to a user that crosses the geofence. However, in some instances, the user that crosses the geofence may not respond to the notification regarding the brick-and-mortar store. Moreover, the geofence may have limited reach, only being able to track users that are proximate to the brick-and-mortar store. Therefore, an additional monitoring geofence that is located further from the brick-and-mortar store may be used by a system to monitor user activity of other users that are located further from the brick-and-mortar store. The system may determine that the user activity within the monitoring geofence indicates an interest in the brick-and-mortar store. Thereafter, a notification may be sent to the other users based on the determination that the user activity indicates interest in the brick-and-mortar store. User activity within the monitoring geofence may include movements made by the user while being within the monitoring geofence. User activity may further include item purchases made by the user while being in the monitoring geofence. In some instances, the system may determine that item purchases made by the user prior to entering the monitoring geofence are indicative of interest in the brick-and-mortar store.

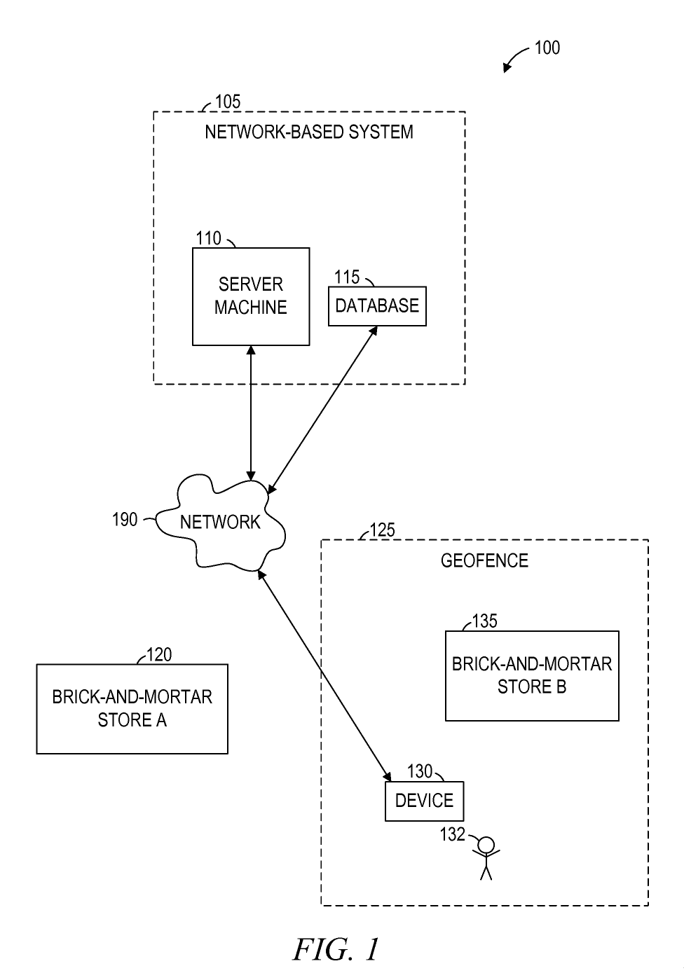

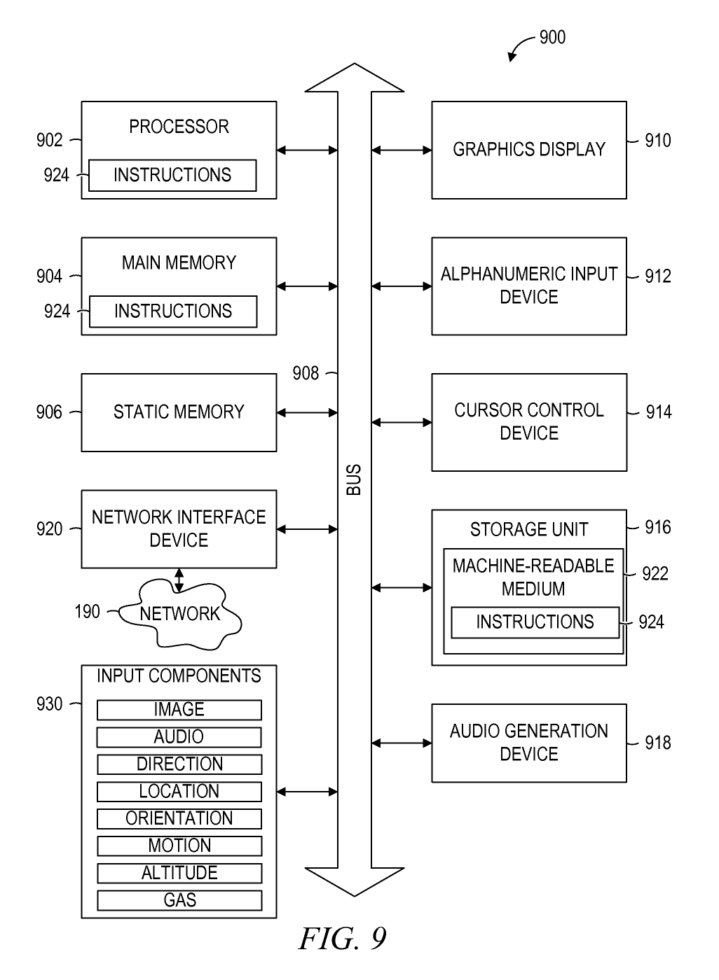

FIG. 1 is a network diagram illustrating a network environment 100 suitable for collecting data to determine interest, according to some example embodiments. The network environment 100 includes a server machine 110, a database 115, and device 130, all communicatively coupled to each other via a network 190. The server machine 110 may form all or part of a network-based system 105 (e.g., a cloud-based server system configured to provide one or more services to the device 130). The server machine 110 and the device 130 may each be implemented in a computer system, in whole or in part, as described below with respect to FIG. 9.

Also shown in FIG. 1 is user 132. The users 132 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132.

The user 132 that crosses into a geofence 125 will cause the server machine 110 to collect data from the device 130 associated with the user 132. The geofence 125 surrounds an identified area. Moreover, the data collected from the device 130 may represent activities performed by the user 132 while being within the identified area surrounded by the geofence 125. Data may also be collected from a database 115 managed by the server machine 110. The collected data may include location data, purchase data, or any suitable combination thereof. Moreover, the server machine 110 may determine whether the collected data indicates an interest on behalf of user 132 in a brick-and-mortar store 120. The identified area may also include a further brick-and-mortar store 135. In some instances, the user 132 may purchase items from the further brick-and-mortar store 135. In some instances, the items purchased from the further brick-and-mortar store 135 are items listed and managed by the server machine 110. Accordingly, information regarding the items purchased by the user 132 from the further brick-and-mortar store 135 may be stored as purchase data by the server machine 110. Alternatively, the purchase data may include items purchased by the user prior to entering the identified area. In some instances, the user 132 may be moving in a direction towards the brick-and-mortar store 120. Information regarding the movement of the user 132 may be sent as location data to the server machine 110.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

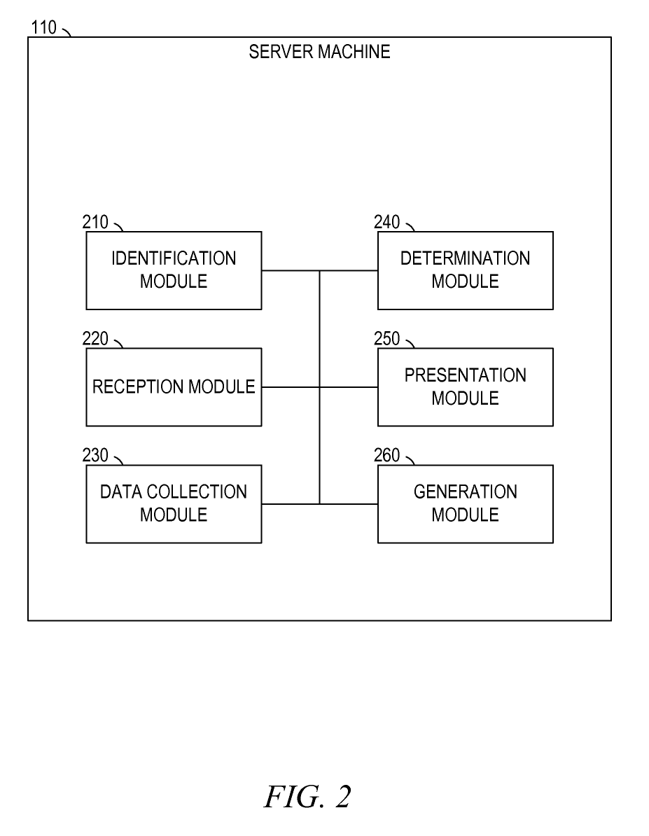

FIG. 2 is a block diagram illustrating components of the server machine 110, according to some example embodiments. The server machine 110 is shown as including an identification module 210, a reception module 220, a data collection module 230, a determination module 240, a presentation module 250, and a generation module 260, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the identification module 210 is configured to identify an area that is a pre-defined distance from a brick-and-mortar store. The identified area may be a region or location that is selected where users may be monitored. Moreover, activities performed by users within the identified area may be indicative of user interest in the brick-and-mortar store. In some instances, the identified area may be a certain fixed distance from the brick-and-mortar store. In various example embodiments, the identification module 210 is further configured to determine that the area includes a physical location that is used to access the brick-and-mortar store. For example, the area may be a freeway exit that leads to the brick-and-mortar store. As another example, the area may be a parking structure that is located near the brick-and-mortar store. In some instances, the area may be a central location with large amounts of traffic passing through. Moreover, the central location may include various modes of transportation that can be used to reach the brick-and-mortar store. For instance, the central location may be a bus station, a train station, an airport, or any suitable combination thereof. In various example embodiments, the identification module 210 is further configured to determine that a threshold number of previous users traveled from the identified area to the brick-and-mortar store. For instance, in the case of the central location, the identification module 210 may determine that the threshold number of users traveled from the central location to the brick-and-mortar store using the various modes of transportation. In the case of the freeway exit, the identification module 210 may determine that the threshold number of users drove from the freeway exit to the brick-and-mortar store. In some instances, the brick-and-mortar store is located outside of the identified area. In other words, the brick-and-mortar store may be located outside of the boundaries of the identified area. For example, the central location may be a train station located 5 miles outside of the brick-and-mortar store. However, the train station may still be related to the brick-and-mortar store because it may be used to access the brick-and-mortar store. Moreover, items purchased at the train station may be related to items available for sale from the brick-and-mortar store. Likewise, the freeway exit may still be related to the brick-and-mortar store because it may be used to access the brick-and-mortar store.

In various example embodiments, the reception module 220 is configured to receive an indication that a user is crossing into the identified area. The indication may be received from a mobile device. Moreover, the indication may be sent from the mobile device based on geofence data that indicates a geofence that surrounds the identified area. In some instances, the mobile device is associated with the user. In other words, as soon as the user crosses into the identified area, the mobile device may send the indication that gets received at the reception module 220. Moreover, the geofence data may be representative of the geofence and may include location coordinates, an address, or any suitable combination thereof. In some cases, the geofence data marks the boundaries of the geofence that surrounds the identified area.

In various example embodiments, the data collection module 230 is configured to periodically collect data from the mobile device. Moreover, the data collection module 230 is further configured to perform the collection of data in response to the indication received at the reception module 220. In various example embodiments, the data collection module 230 is further configured to collect a first location of the mobile device from the mobile device during a first moment. In some instances, the first moment is when the user enters the identified area. The data collection module 230 is also further configured to collect a second location of the mobile device from the mobile device during a second moment. Moreover, the second moment occurs a predetermined period of time after the first moment. In some instances, both the first and second locations are included in the identified area. In some instances, the area includes a further brick-and-mortar store. Moreover, the further brick-and-mortar store may carry items that are related to or similar to items available for sale at the brick-and-mortar store. For example, the central location may include kiosks with items available for sale. Moreover, the items sold at the kiosks may be similar to items available for sale at the brick-and-mortar store. In various example embodiments, the data collection module 230 is further configured to collect purchase data of items purchased by the user. In some instances, the items may be purchased from the further brick-and-mortar store. Alternatively, the items may have been purchased by the user prior to entering the identified area. Moreover, the data collection module 230 may be further configured to retrieve the purchase data from a database managed by the server machine 110. In various example embodiments, the data collection module 230 is further configured to periodically collect the data from the mobile device while the mobile device is within the identified area. In other words, once the mobile device travels outside of the identified area, the data collection module 230 may cease to collect data from the mobile device. In various example embodiments, the data collection module 230 is further configured to collect a current location of the mobile device.

In various example embodiments, the determination module 240 is configured to determine that the data collected from the mobile device indicates an interest in the brick-and-mortar store. Moreover, the data collected from the mobile device may represent activities performed by the user while being within the identified area. In various example embodiments, the determination module 240 is further configured to calculate a first distance between the first location of the mobile device and the brick-and-mortar store. In various example embodiments, the determination module 240 is further configured to calculate a second distance between the second location of the mobile device and the brick-and-mortar store. Moreover, the determination module 240 may be further configured to determine that the first distance is greater than the second distance. In other words, the determination module 240 may determine that the user is traveling closer to the brick-and-mortar store. In various example embodiments, the determination module 240 is further configured to determine that item characteristics of the items purchased by the user correspond to item characteristics of items available for sale at the brick-and-mortar store. For instance, the brick-and-mortar store may carry items that are similar to items purchased by the user either from the further brick-and-mortar store or purchased by the user prior to entering the identified area. In either case, a purchase history of the user may be stored in a database maintained by the server machine 110. As another example, the brick-and-mortar store may carry items that are related to the items purchased by the user from the either further brick-and-mortar store or purchased by the user prior to entering the identified area. In either case, a purchase history of the user may be stored in a database maintained by the server machine 110.

In various example embodiments, the presentation module 250 is configured to present a notification to the mobile device based on the determination performed by the determination module 240. In various example embodiments, the determination of interest in the brick-and-mortar store correlates with a level of responsiveness on behalf of the user to the notification presented on the mobile device. The notification may be information regarding the brick-and-mortar store. For instance, the notification may indicate certain items available for sale from the brick-and-mortar store as well as the location of the brick-and-mortar store. The notification may also reference the data collected by the data collection module 230. For example, the notification may indicate to the user that the user is traveling closer to the brick-and-mortar store. The notification may further indicate to the user that the brick-and-mortar store has items that similar to items previously purchased by the user.

In various example embodiments, the presentation module 250 is further configured to send the geofence data generated by the generation module 260 to the mobile device.

In various example embodiments, the generation module 260 is configured to generate the geofence data that indicates the geofence that surrounds the identified area. The geofence data may be representative of the geofence and may include location coordinates, an address, or any suitable combination thereof. In some cases, the geofence data marks the boundaries of the geofence that surrounds the identified area. In various example embodiments, the generation module 260 accesses a map to obtain location information regarding the identified area. Accordingly, the generation module 260 is further configured to generate the geofence that surrounds the identified area based on the location information regarding the identified area. Location information regarding the identified area may be represented as a certain radius around a midpoint, a set of location points, and the like.

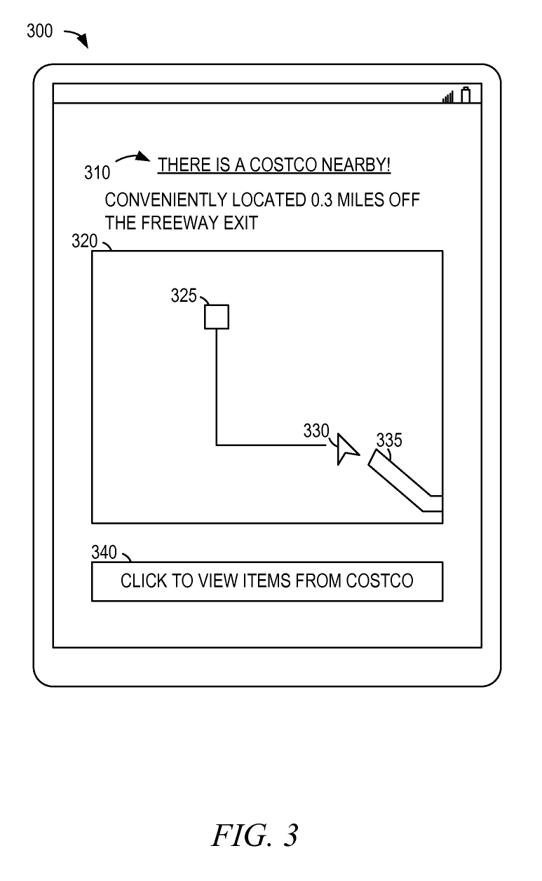

FIG. 3 is an example user interface 300 illustrating a notification presented on a screen of a mobile device, according to some example embodiments. The notification may be received by the mobile device while being within an area identified by the identification module 210. The user interface 300 may include a message 310 that indicates a brick-and-mortar store as well as its distance from the mobile device. The user interface 300 further includes a map 320 displaying the brick-and-mortar store 325 in relation to a current location of the mobile device 330. The map 320 may also display a freeway exit 335 that leads to the brick-and-mortar store 325. A user operating the mobile device may have taken the freeway exit 335 displayed in the map 320. Moreover, the area identified by the identification module 210 may include the freeway exit 335. Further, the user interface 300 may include a control 340 operable to view items from the brick-and-mortar store 325.

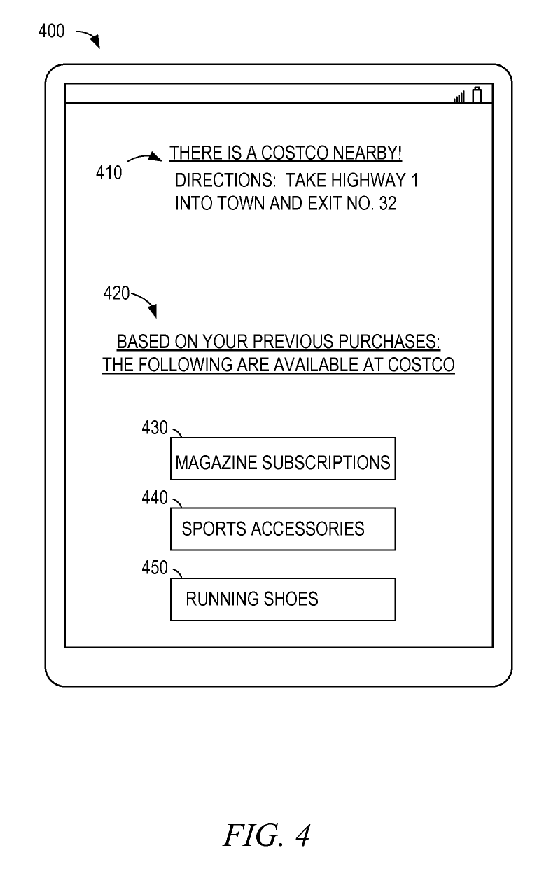

FIG. 4 is an example user interface 400 illustrating a notification presented on a screen of a mobile device, according to some example embodiments. The notification may be received by the mobile device while being within an area identified by the identification module 210. The user interface 400 may include a first message 410 that indicates a brick-and-mortar store. The first message 410 may also include directions on how to reach the brick-and-mortar store from the identified area. The user interface 400 may also include a second message 420 that indicates data collected by the data collection module 230. The data may represent activities performed by a user associated with the mobile device while being within the area identified by the identification module 210. The user interface 400 further includes controls 430, 440, and 450. Each of controls 430, 440, and 450 corresponds to an item or good available for sale from the brick-and-mortar store. Moreover, the controls 430, 440, and 450 are operable to present additional information on an item or good available for sale from the brick-and-mortar store.

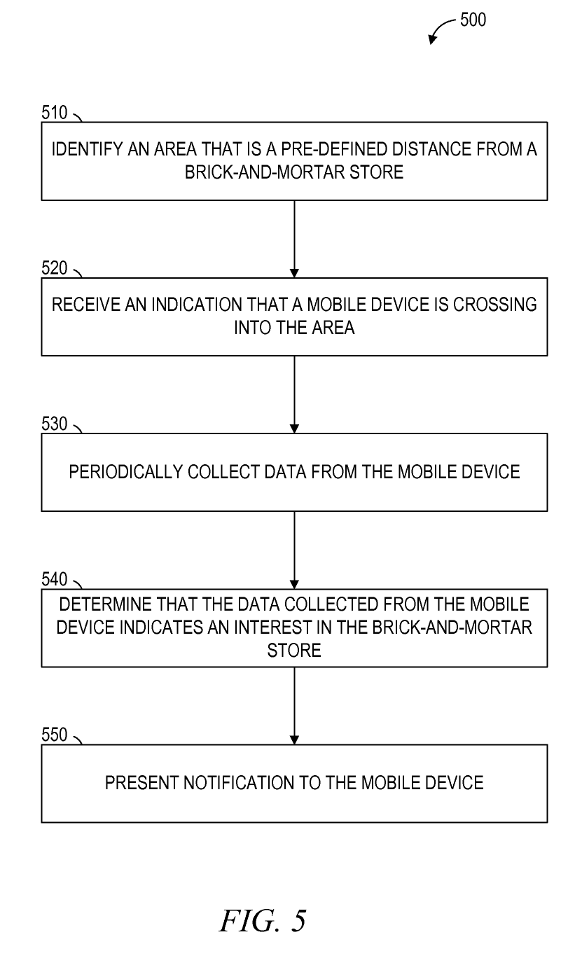

FIG. 5-8 are flowcharts illustrating operations of the server machine 110 in performing a method 500 of determining that data collected from a mobile device indicates an interest in the brick-and-mortar store, according to some example embodiments. Operations in the method 500 may be performed by the server machine 110, using modules described above with respect to FIG. 2. As shown in FIG. 5, the method 500 includes operations 510, 520, 530, 540, and 550.

At operation 510, the identification module 210 identifies an area that is a pre-defined distance from a brick-and-mortar store. The identified area may be a region or location that is selected where users may be monitored. Moreover, activities performed by the users within the identified area may be indicative of user interest in the brick-and-mortar store. In some instances, a merchant of the brick-and-mortar store may provide a location of the brick-and-mortar store that is used by the identification module 210 to identify the area that is the pre-defined distance from the brick-and-mortar store.

At operation 520, the reception module 220 receives an indication that a user is crossing into the identified area. The indication may be received from a mobile device associated with the user.

At operation 530, the data collection module 230 periodically collects data from the mobile device. In other words, the data collection module 230 may collect data from the mobile device more than once at various moments throughout a given period.

At operation 540, the determination module 240 determines that the data collected from the mobile device indicates an interest in the brick-and-mortar store. Moreover, the data collected from the mobile device may represent activities performed by the user while being within the identified area.

At operation 550, the presentation module 250 presents a notification to the mobile device based on the determination performed by the determination module 240 at operation 540. The notification may be information regarding the brick-and-mortar store. For instance, the notification may indicate certain items available for sale from the brick-and-mortar store as well as the location of the brick-and-mortar store. The notification may also reference the data collected from the mobile device by the data collection module 230.

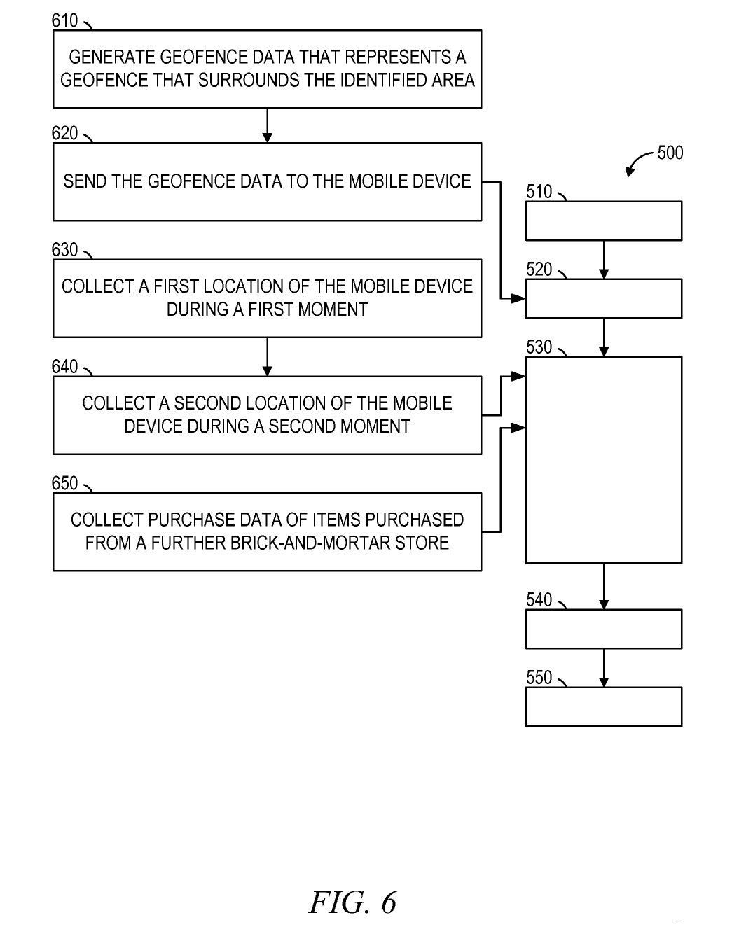

As shown in FIG. 6, the method 500 may include one or more of operations 610, 620, 630, 640, and 650. One or more of operations 610 and 620 may be performed as part (e.g., a precursor task, a subroutine, or a portion) of operation 520. One or more of operations 630-650 may be performed as part (e.g., a precursor task, a subroutine, or a portion) of operation 530.

At operation 610, the generation module 260 generates geofence data that indicates the geofence that surrounds the identified area. In some instances, the geofence data marks the boundaries of the identified area. For instance, the geofence data may include location coordinates, address information, or any suitable combination thereof.

At operation 620, the presentation module 250 sends the geofence data to the mobile device.

At operation 630, the data collection module 230 collects a first location of the mobile device during a first moment. The first location may be indicated by GPS location coordinates, an address, an area on a map, or any suitable combination thereof. Moreover, the first location may include a timestamp that corresponds to the first moment during which the first location was collected by the data collection module 230.

At operation 640, the data collection module 230 collects a second location of the mobile device during a second moment. The second location may be indicated by GPS location coordinates, an address, an area on a map, or any suitable combination thereof. Moreover, the second location may include a timestamp that corresponds to the second moment during which the second location was collected by the data collection module 230.

At operation 650, the data collection module 230 collects purchase data of items purchased from a further brick-and-mortar store. The purchase data may include receipts, browsing history, and the like. In various example embodiments, the data collection module 230 collects the purchase data from a database maintained by the server machine 110.

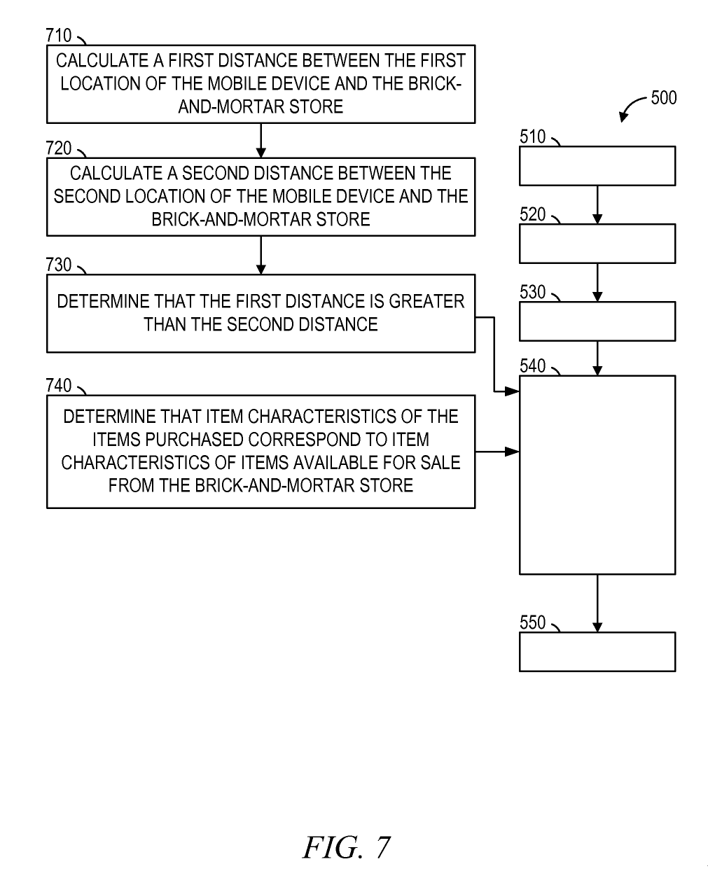

As shown in FIG. 7, the method 500 may include one or more of operations 710, 720, 730, and 740. One or more of operations 710-740 may be performed as part (e.g., a precursor task, a subroutine, or a portion) of operation 540.

At operation 710, the determination module 240 calculates a first distance between the first location of the mobile device and the brick-and-mortar store.

At operation 720, the determination module 240 calculates a second distance between the second location of the mobile device and the brick-and-mortar store.

At operation 730, the determination module 240 determines that the first distance is greater than the second distance. As stated previously, the first distance is a calculated distance between the first location of the mobile device and the brick-and-mortar store. Moreover, the second distance is a calculated distance between the second location of the mobile device and the brick-and-mortar store.

At operation 740, the determination module 240 determines that item characteristics of the items purchased from the further brick-and-mortar store correspond to item characteristics of items available for sale from the brick-and-mortar store. For instance, the brick-and-mortar store may carry items that are similar to items purchased by the user from the further brick-and-mortar store. As another example, the brick-and-mortar store may carry items that are related to the items purchased by the user from the further brick-and-mortar store. The items purchased from the further brick-and-mortar store may be stored as purchase history data in a database maintained by the server machine 110.

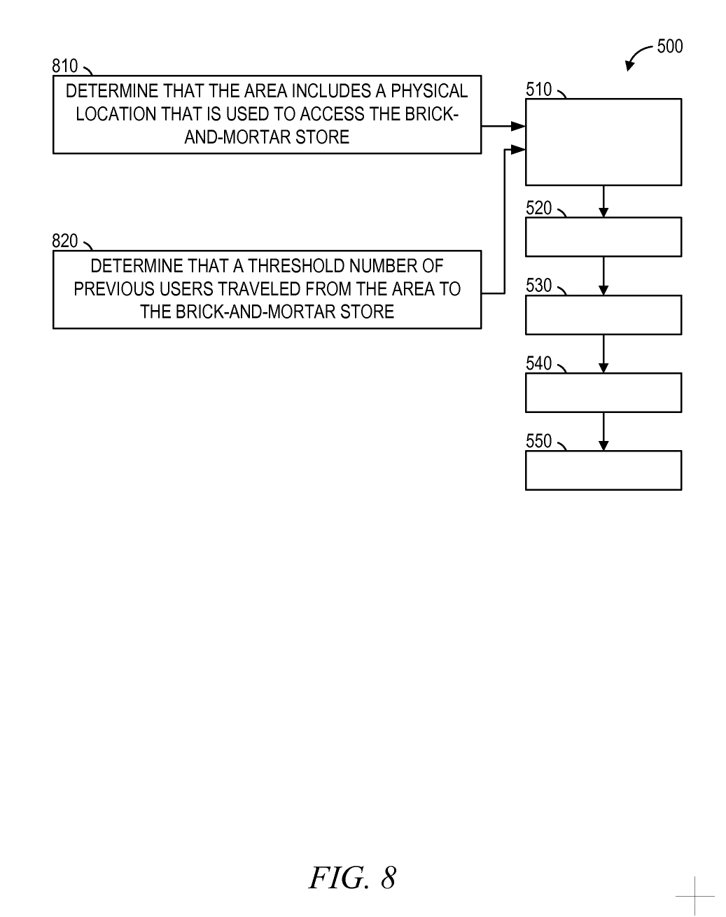

As shown in FIG. 8, the method 500 may include one or more of operations 810, and 820. One or more of operations 810 and 820 may be performed as part (e.g., a precursor task, a subroutine, or a portion) of operation 510.

At operation 810, the identification module 210 determines that the area (identified in operation 510) includes a physical location that is used to access the brick-and-mortar store. For example, the area may be a freeway exit that leads to the brick-and-mortar store. As another example, a parking structure that located near the brick-and-mortar store may be included as part of the area. In some instances, the area may be a central location with large amounts of traffic passing through. Moreover, the central location may include various modes of transportation that can be used to reach the brick-and-mortar store.

At operation 820, the identification module 210 determines that a threshold number of previous users traveled from the area (identified in operation 510) to the brick-and-mortar store.

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media (e.g., tangible and non-transitory machine-readable media). The instructions 924 may be transmitted or received over the network 190 via the network interface device 920. For example, the network interface device 920 may communicate the instructions 924 using any one or more transfer protocols (e.g., hypertext transfer protocol (HTTP)).

In some example embodiments, the machine 900 may be a portable computing device, such as a smart phone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
identifying an area that is a pre-defined distance from a brick-and-mortar store;
receiving an indication, from a mobile device associated with a user, that the user is crossing into the identified area, the indication being sent from the mobile device based on geofence data that indicates a geofence that surrounds the identified area;
in response to receipt of the indication, periodically collecting data from the mobile device;
determining, using one or more processors, that the data collected from the mobile device indicates interest in the brick-and-mortar store; and
presenting a notification to the mobile device based on the determination.

2. The method of claim 1, further comprising:
generating the geofence data that indicates the geofence that surrounds the identified area; and
prior to receiving the indication from the mobile device, sending the geofence data to the mobile device.

3. The method of claim 1, wherein the periodically collecting data from the mobile device includes:
collecting a first location of the mobile device during a first moment; and
collecting a second location of the mobile device during a second moment, wherein the first and second locations are both included in the identified area.

4. The method of claim 3, wherein the determining that the data collected from the mobile device indicates interest in the brick-and-mortar store includes:
calculating a first distance between the first location of the mobile device and the brick-and-mortar store;
calculating a second distance between the second location of the mobile device and the brick-and-mortar store; and
determining that the first distance is greater than the second distance.

5. The method of claim 1, wherein the identified area includes a further brick-and-mortar store, and wherein the periodically collecting data from the mobile device includes:
collecting purchase data of items purchased from the further brick-and-mortar store.

6. The method of claim 5, wherein the determining that the data collected from the mobile device indicates interest in the brick-and-mortar store includes:
determining that item characteristics of the items purchased from the further brick-and-mortar store correspond to item characteristics of items available for sale at the brick-and-mortar store.

7. The method of claim 1, wherein the brick-and-mortar store is located outside of the identified area.

8. The method of claim 1, wherein the periodically collecting the data from the mobile device is performed while the mobile device is within the identified area.

9. The method of claim 1, wherein the identifying the area includes:
determining that the area includes a physical location that is used to access the brick-and-mortar store.

10. The method of claim 1, wherein the identifying the area includes:
determining that a threshold number of previous users traveled from the area to the brick-and-mortar store.

11. A system comprising:
an identification module configured to identify an area that is a pre-defined distance from a brick-and-mortar store;
a reception module configured to receive an indication, from a mobile device associated with a user, that the user is crossing into the identified area, the indication being sent from the mobile device based on geofence data that indicates a geofence that surrounds the identified area;
a data collection module configured to periodically collect data from the mobile device, the collection performed in response to receipt of the indication;
a processor-implemented determination module configured to determine that the data collected from the mobile device indicates interest in the brick-and-mortar store; and
a presentation module configured to present a notification to the mobile device based on the determination.

12. The system of claim 11, further comprising:
a generation module configured to generate the geofence data that indicates the geofence that surrounds the identified area, and wherein the presentation module is further configured to send the geofence data to the mobile device.

13. The system of claim 11, wherein the data collection module is further configured to:
collect a first location of the mobile device during a first moment; and
collect a second location of the mobile device during a second moment, wherein the first and second locations are both included in the identified area.

14. The system of claim 13, wherein the determination module is further configured to:
calculate a first distance between the first location of the mobile device and the brick-and-mortar store;
calculate a second distance between the second location of the mobile device and the brick-and-mortar store; and
determine that the first distance is greater than the second distance.

15. The system of claim 11, wherein the area includes a further brick-and-mortar store, and wherein the data collection module is further configured to:
collect purchase data of items purchased from the further brick-and-mortar store.

16. The system of claim 15, wherein the determination module is further configured to:
determine that item characteristics of the items purchased from the further brick-and-mortar store correspond to item characteristics of items available for sale at the brick-and-mortar store.

17. The system of claim 11, wherein the data collection module is further configured to collect the data from the mobile device while the mobile device is within the area.

18. The system of claim 11, wherein the identification module is further configured to determine that the area includes a physical location that is used to access the brick-and-mortar store.

19. The system of claim 11, wherein the identification module is further configured to determine that a threshold number of previous users traveled from the area to the brick-and-mortar store.

20. A non-transitory machine-readable medium storing instructions that, when executed by one or more processors of a machine, cause the machine to perform operations comprising:
identifying an area that is a pre-defined distance from a brick-and-mortar store;
receiving an indication, from a mobile device associated with a user, that the user is crossing into the identified area, the indication being sent from the mobile device based on geofence data that indicates a geofence that surrounds the identified area;
in response to receipt of the indication, periodically collecting data from the mobile device;
determining that the data collected from the mobile device indicates interest in the brick-and-mortar store; and
presenting a notification to the mobile device based on the determination.
